(19) United States
(12) Patent Application Publication
(10) Pub. No.: US 2026/0245452 A1
(43) Pub. Date: Aug. 20, 2026

(54) Method and Apparatus for Determine a Risk Profile of a Traffic Participant of a Traffic Scenario

(71) Applicant: Siemens Aktiengesellschaft, München (DE)

(72) Inventors: Rhena Kieffer, München (DE); Iris Fuhrmann, Bad Driburg (DE); Jens Kutschera, Kassel (DE); Igor Passchier, The Hague (NL)

(73) Assignee: Siemens Aktiengesellschaft, München (DE)

(21) Appl. No.: 19/159,502

(22) PCT Filed: Feb. 28, 2023
(86) PCT No.: PCT/EP2023/055016

§ 371 Date: Aug. 25, 2025

(51) Int. Cl. G08G 1/01; B60W 60/00; G08G 1/0967; G08G 1/16

(52) U.S. Cl. CPC G08G 1/0133; G08G 1/096725; G08G 1/16; B60W 60/001; B60W 2554/00

(57) ABSTRACT

Provided is a method and an apparatus (100) for determining a risk profile of a traffic participant (12) of a traffic scenario (10). The apparatus (100) comprises interface circuitry (110) configured to receive first data (112) indicating a behavior of the traffic participant (12) and a behavior of surrounding traffic (14) in the traffic scenario, and to receive second data (114) indicating at least one failure mode that can be occurred at the traffic participant (12) to obtain a second risk indicator for hazards for the traffic participant (12). The apparatus further comprises processing circuitry (120) configured to determine a first risk indicator for hazards for the traffic participant (12) based on the first data (112), to combine the first risk indicator and the second risk indicator to obtain the risk profile of the traffic participant (12) in the traffic scenario (10), and to provide the risk profile as output data (122).

### CROSS-REFERENCE TO RELATED APPLICATIONS

This application is a U.S. National Stage Application of International Application No. PCT/EP 2023/055016 filed Feb. 28, 2023, which designates the United States of America, the contents of which are hereby incorporated by reference in their entirety.

### TECHNICAL FIELD

The present disclosure relates to traffic management. Various embodiments of the teachings herein include methods and/or systems for determining a risk profile of a traffic participant of a traffic scenario and/or for controlling operation of a self-driving vehicle.

### BACKGROUND

Participation in traffic, in particular public road traffic, is subject to various risks. For example, in traffic there is a general risk that two traffic participants may endanger each other, collide, etc. Further, the deployment of self-driving vehicles, also referred to as autonomous vehicles, introduces a new type of risk since machine interact with others, also non-machine, traffic participants, such as pedestrians, cyclists, etc.

Risk is commonly assessed by frequency and severity of certain events, e. g. accidents in traffic. However, for new endeavors, such as the deployment of self-driving vehicles on public roads, there is not enough historical data that can be used to estimate a corresponding risk accurately. Even if self-driving cars are already driving on public roads, it is very cost-intensive and takes a long time to collect enough data to estimate the risk based on a frequency and severity analysis for certain events and/or specific locations. Hence, there is a need for improved risk assessment of traffic participants.

### SUMMARY

Various embodiments of the teachings herein include methods and/or systems for determining a risk profile of a traffic participant of a traffic scenario and/or for controlling operation of a self-driving vehicle.

For example, some embodiments of the teachings herein include method for determining a risk profile of a traffic participant (12) of a traffic scenario (10) comprising: receiving first data (112) indicating a behavior of the traffic participant (12) and a behavior of surrounding traffic (14) in the traffic scenario (10), determining a first risk indicator for hazards for the traffic participant (12) based on the first data; receiving second data (114) indicating at least one failure mode that can be occurred at the traffic participant (12) to obtain a second risk indicator for hazards for the traffic participant (12); combining the first risk indicator and the second risk indicator to obtain the risk profile of the traffic participant (12) in the traffic scenario (10); and providing the risk profile as output data (122).

In some embodiments, the output data is provided and/or used for determining control data for and/or controlling of a self-driving vehicle based on the risk profile.

In some embodiments, the first data (112) comprises movement trajectory data of the traffic participant (12) and/or the surrounding traffic indicating the respective behavior.

In some embodiments, determining the first risk indicator further comprises analyzing the movement trajectory data for its hazardous effect to the traffic participant (12).

In some embodiments, the first data (112) is configured time-step based, each time-step indicating a specific movement scene including the traffic participant (12) and/or the surrounding traffic (14), and determining the first risk indicator further comprises: determining, for a number of the time-steps, a respective sub-risk indicator by analyzing the respective movement of the traffic participant (12) and/or the surrounding traffic (14) for its hazardous for the traffic participant (12) ; and aggregating the sub-risk indicators of the number of the time-steps to obtain the first risk indicator.

In some embodiments, determining the first risk indicator and/or the second risk indicator is further based on at least one environmental condition affective for the traffic scenario (10).

In some embodiments, determining the first risk indicator is further based on a type of at least one co-traffic participant (12) identified to be present in the surrounding traffic (14).

In some embodiments, the first data (112) is at least partially derived from real-life data capturing the traffic scenario (10).

In some embodiments, the first data (112) is at least partially derived from simulated data comprising a plurality of traffic simulations including the traffic participant (12) and/or the surrounding traffic (14) for the traffic scenario (10).

In some embodiments, the second data (114) comprises at least one safety metric indicating the corresponding at least one failure mode of the traffic participant (12).

In some embodiments, the failure mode relates to a failure of a technical system and/or a likelihood of a failure of a technical system of the traffic scenario (10).

In some embodiments, the first data (112) is configured time-step based, each time-step indicating a specific scene of the traffic scenario (10), and wherein combining the first risk indicator and the second risk indicator further comprises: determining, for a number of the time-steps, the respective hazardous effect of and/or a likelihood for the at least one failure mode for the traffic participant (12) ; and aggregating the respective hazardous effect and/or likelihood of the number of the time-steps to obtain the risk profile.

In some embodiments, the traffic scenario (10) comprises or is assigned to a specific geographic location or region and/or comprises at least one of a traffic segment, a road, a road segment, a route, an area, and an intersection.

As another example, some embodiments include a method for controlling operation of a self-driving vehicle, the method comprising: receiving output data indicating a risk profile of a traffic participant (12) of a traffic scenario (10) provided according to the method of any one of the preceding claims, wherein the operation of the self-driving vehicle is related to participating the traffic scenario (10); generating control data for the self-driving vehicle based on the risk profile; and controlling operation of the self-driving vehicle based on the control data.

As another example, some embodiments include an apparatus (100) for determining a risk profile of a traffic participant (12) of a traffic scenario (10), the apparatus (100) comprising: interface circuitry (110) configured to: receive first data (112) indicating a behavior of the traffic participant (12) and a behavior of surrounding traffic (14) in the traffic scenario; and receive second data (114) indicating at least one failure mode that can be occurred at the traffic participant (12) to obtain a second risk indicator for hazards for the traffic participant (12); and processing circuitry (120) configured to: determine a first risk indicator for hazards for the traffic participant (12) based on the first data (112); combine the first risk indicator and the second risk indicator to obtain the risk profile of the traffic participant (12) in the traffic scenario (10); and provide the risk profile as output data (122).

### BRIEF DESCRIPTION OF THE DRAWINGS

Some embodiments of apparatuses and/or methods will be described in the following by way of example only, and with reference to the accompanying figures, in which:

FIG. 1 illustrates in a schematic block diagram an exemplary apparatus for determining a risk profile of a traffic participant of a traffic scenario;

FIG. 2 illustrates in a schematic block diagram an example of data processing for deriving first data indicating a behavior of the traffic participant and a behavior of surrounding traffic in a traffic scenario;

FIG. 3 illustrates an exemplary traffic scenario with a rather high risk for a traffic participant in the context of surrounding traffic;

FIG. 4 illustrates an exemplary traffic scenario with a rather low risk for a traffic participant in the context of surrounding traffic;

FIG. 5 illustrates in a schematic block diagram an example of data processing for deriving a risk profile for a traffic participant in a traffic scenario;

FIG. 6 illustrates in a flow chart an exemplary method for determining a risk profile of a traffic participant of a traffic scenario; and

FIG. 7 illustrates in a flow chart an exemplary method for controlling operation of a self-driving vehicle.

### DETAILED DESCRIPTION

Some embodiments of the teachings herein include a method for determining a risk profile of a traffic participant of a traffic scenario. An example method comprises receiving first data indicating a behavior of the traffic participant and a behavior of surrounding traffic in the traffic scenario. Further, the method comprises determining a first risk indicator for hazards for the traffic participant based on the first data. The method further comprises receiving second data indicating at least one failure mode that can be occurred at the traffic participant to obtain a second risk indicator for hazards for the traffic participant. In addition, the method comprises combining the first risk indicator and the second risk indicator to obtain the risk profile of the traffic participant in the traffic scenario. Further, the method comprises providing the risk profile as output data.

The methods described herein allow for determining, e.g. estimating, assessing, predicting, etc. the risk of the traffic participant under consideration for any traffic scenario indicated by the first and/or second data. Accordingly, this allows for classifying the risk of the traffic participant under consideration associated with the traffic scenario under consideration, e.g. with a specific location, a traffic domain, or the like, and to indicate such risk as the first risk indictor. Further, the method allows for combining such risk indicated by the first risk indicator with an individual risk for failure at the traffic participant under consideration, which is indicated by the second risk indicator, to derive an individual overall risk, e.g. an assessment, estimation, prediction, or the like, of that overall risk, for the traffic participant for or in the traffic scenario under consideration, which overall risk is indicated by the risk profile. Such risk profile may be used in various ways in the context of traffic management.

Although such a profile may be useful for e.g. insurance companies, for example, in order to classify certain means of transport into appropriate insurance classes on the basis of their risk profile, the method can be used for technical purposes, such as for traffic planning, traffic controlling, e.g. to operate traffic control systems, the development of self-driving vehicles, e.g. in driving strategy development, to operate and/or control self-driving cars, which may also be referred to as autonomous vehicles, such as route planning for self-driving cars, for navigation computations of vehicle navigation systems, etc. In other words, the method described herein combines risk associated with the behavior of any traffic participant under consideration and surrounding traffic, e.g. co-participants, traffic regulation, or the like, for example, capturing hazards arising from the surrounding traffic, in any traffic scenario indicted by the first data with the individual failure risk of the traffic participant under consideration indicated by the second data. The risk profile may therefore also be determined at least substantially without requiring historical data on e.g. accidents or the like.

The method may be computer-implemented and may be carried out by any suitable data processor, computation device, or the like. The method may be carried out by a single entity or by multiple entities, a distributed computer system, etc.

As used herein, the traffic participant may be of any kind, such as a vehicle, self-driving, vehicle, motorbike, bicycle, pedestrian, etc. For example, the method may be performed for an ego traffic participant, such as an ego vehicle, e.g., also ego-self-driving vehicle, and/or for any other traffic participant, e.g. of the surrounding traffic surrounding the traffic participant, indicated by the first and/or second data. The traffic scenario may be any kind of traffic situation, driving scenario, driving manoeuvre, or the like, bearing a risk for any traffic participant of it. For example, the traffic scenario may comprise or may be assigned to a specific geographic location, area or region and/or may comprise or may be assigned to at least one of a traffic segment, a road, a road segment, a route, an area, an intersection, or the like. The traffic scenario may comprise traffic regulation, such as traffic control systems, traffic signs, traffic lights, traffic guidance systems, or the like.

The first risk indicator may also be understood as an indicator, measure, quantification, or the like, for behavioral and surrounding traffic risk. It may be or may comprise an estimation, prediction of the risk which is influenced by the respective behavior. The first indicator may depend on one or more of traffic density, road layout, behavior of the traffic participant, e.g. ego traffic participant, behavior of the other traffic participants, i.e. co-participants, etc. For example, the first risk indicator may be computed based on the first data. It may be indicated as a corresponding value, likelihood, or the like, in relative or absolute value, etc.

The second risk indicator may also be understood as an indicator, measure, quantification, or the like, for traffic participant failure risk. It may be based on or derived from knowledge, an estimation, a computation, a metric, a specification, or the like, corresponding to the traffic participant. The second risk indicator may be specific for the traffic participant under consideration. For example, the failure mode indicated by the second risk indicator may be any type of failure that in principle appears possible within the sphere of influence and/or control of the traffic participant and is accordingly recorded as data, i.e. the second data. By way of example, the second data may be based on derived from a safety case, safety study, a specification, etc. for the traffic participant under consideration. It may also be based on or derived from historic data. In at least some examples, the second data may also be based on or derived from statistical data. For example, the failure mode may be related to a system failure, component failure, but also to a behavioural failure, e.g., poor visibility, glare, distraction, etc. The second risk indicator may be computed based on the second data. It may be indicated as a corresponding value, likelihood, or the like, in relative or absolute value, etc.

The risk profile may also be understood as a combined, also as an overall, risk measure, quantification, that considers both the behavioural and surrounding traffic risk and the individual participant failure risk of the traffic participant under consideration. The combination allows an accurate determination, e.g. estimation, prediction, etc., of the hazard potential, i.e. the overall risk, of the traffic participant. The risk profile may be computed based on the first data and second data. It may be indicated as a corresponding value, likelihood, or the like, in relative or absolute value, etc. The risk profile is output as the output data, which may be further processed.

In at least some examples, the output data may be provided and/or used for determining control data for and/or controlling of a self-driving vehicle based on the risk profile. For example, the risk profile may be used to indicate the overall risk of driving on a specific road, route or area, also for a given set of conditions, e.g., time of day, time of year, weather, etc. Thus, driving missions, routes, driving maneuvers, or the like, may be selected, recommended, altered, avoided, etc. based on the risk profile.

In at least some examples, the first data may comprise movement trajectory data of the traffic participant and/or the surrounding traffic indicating the respective behavior. For example, the first data may be at least partially derived from real-life data, including sensor data, camera data, radar data, lidar data, or the like, at least partially capturing the traffic scenario. From such real-life data one or more trajectories of the detected and/or identified objects present in the traffic scenario may be derived, calculated, estimated, predicted, etc. Further, by way of example, the first data may be at least partially derived from simulated data. From such simulated data one or more trajectories of the detected and/or identified objects present in the traffic scenario may be derived, calculated, estimated, predicted, etc. From the analysis, e.g. tracking, simulation, or the like, of the respective trajectories individually and/or in combination, the respective behavior may be determined.

In at least some examples, determining the first risk indicator may further comprise analyzing the movement trajectory data for its hazardous to the traffic participant. For example, close trajectories may be hazardous or dangerous because they may at least encourage a collision between corresponding traffic participants, or of the traffic participant and a static obstacle present in the traffic scenario, e.g. a traffic sign, traffic light, vegetation, buildings, etc. Further, by way of example, narrow trajectories, in particular at high velocity and/or high acceleration or deceleration, may also pose a potential hazard.

In at least some examples, analyzing the movement trajectory data may comprise at least one of determining a distance and count of one or more movement trajectories included in the movement trajectory data, determining a time-to-collision, TTC, of one or more movement trajectories included in the movement trajectory data, or determining reachability of one or more movement trajectories included in the movement trajectory data. These approaches may differ in complexity, accuracy, and focus. Further, each of these approaches may provide a metric to measure the exposure of the traffic participant to hazardous situations. Further, these approaches may also consider one or more of velocity, acceleration, distance, travel direction, or the like, of the traffic participant and/or the surrounding traffic.

In at least some examples, the first data may be configured time-step based, each time-step indicating a specific movement scene including the traffic participant and/or the surrounding traffic. The determining of the first risk indicator may further comprise determining, for a number of the time-steps, a respective sub-risk indicator by analyzing the respective movement of the traffic participant and/or the surrounding traffic for its hazardous for the traffic participant and aggregating the sub-risk indicators of the number of the time-steps to obtain the first risk indicator. For example, the traffic scenario may be divided into several movement scenes, wherein from one driving scene to the next the traffic participant and/or the surrounding traffic may move, respectively. In such case, the first data, may be analyzed time-step-wise to determine the respective sub-risk indicator for the corresponding movement scene. Aggregating the sub-risk indicators may be provide the first risk indicator or at least part of it.

In at least some examples, determining the first risk indicator and/or the second risk indicator may be further based on at least one environmental condition affective for the traffic scenario. For example, the environmental condition may include natural conditions, traffic conditions, etc.

In at least some examples, the at least one environmental condition may comprise at least one of a weather condition, a traffic density, and a traffic control restriction. For example, the weather condition may indicate visibility conditions, driving mechanics conditions, or the like. For instance, the traffic control restriction may indicate turning prohibition, or the like.

In at least some examples, determining the first risk indicator may be further based on a type of at least one co-traffic participant identified to be present in the surrounding traffic. For example, a bicycle may have a different potential hazard than a car, larger or smaller in some respects, etc.

In at least some examples, the first data may be at least partially derived from real-life data capturing the traffic scenario. For example, the first data may be based on or may comprise sensor data, camera data, radar data, lidar data, or the like. However, the first data may be further processed, for example, with simulations based on the captured data.

In at least some examples, the first data may be at least partially derived from simulated data comprising a plurality of traffic simulations including the traffic participant and/or the surrounding traffic for the traffic scenario. For example, the method may utilize a traffic simulator configured to simulate the traffic scenario or scenes of it. The simulation may be based on an indication of the traffic scene such as a configuration, setting, route specification, geographic location, or the like, and/or on real life data, wherein the simulation further simulates, estimates or predicts the captured real-life data for the future.

In at least some examples, the second data may comprise at least one safety metric indicating the corresponding at least one failure mode of the traffic participant. The safety metric may be derived from any suitable data source, such as a specification, a safety case, a safety study, historic data, statistics. The safety metric may relate to a system, component, or the like, of the traffic participant under consideration. For example, the failure mode, and e.g. reliability, may be obtained from a generic or specific safety case. In some examples, this may comprise a generic high-level safety case for the traffic participant, e.g. self-driving car, within a given operational design domain (ODD) and driving missions based on IS 026262, ISO 21448, UL 4600. In some examples, this may comprise using the top level(s) of a specific safety case provided by the manufacturer of the self-driving car. For vehicles without a released safety case, assumed resilience may be derived against each failure mode. E.g., for prototypes which can prove QM developed systems, QM reliability rating may be used.

In at least some examples, the failure mode relates to a failure of a technical system, component, or the like and/or a likelihood of a failure of a technical system, component, etc., of the traffic scenario and/or traffic participant. For example, the technical system may be configured to perform a vehicle function, driving function, etc. It may also refer to traffic control, or the like. In at least some examples, determining the second risk indicator may further comprise determining a time span between failure occurrences indicating the likelihood of the corresponding failure. The time span, e.g. mean time or the like, between failure may indicate how often the traffic participant, e.g. self-driving car, is expected to fail in general or for during a specific maneuver, e.g. lane keeping, braking, overtaking, etc. For this, the second data may be configured to enable conclusions to be drawn with respect to mean time between failure (type).

In at least some examples, the first data may be configured time-step based, each time-step indicating a specific scene of the traffic scenario. Combining the first risk indicator and the second risk indicator may further comprise determining, for a number of the time-steps, the respective hazardous effect of and/or a likelihood for the at least one failure mode for the traffic participant and aggregating the respective hazardous effect and/or likelihood of the number of the time-steps to obtain the risk profile. For example, for each time-step in the first data, it may be determined, evaluated, assessed, estimated, or the like, whether a respective failure mode could lead to a hazardous event, and what the likelihood of such an event would be. By using e.g. mean time between failure from the second data, e.g. safety case, the likelihood and severities of these hazardous events may be computed. Based on this, the per time-step for e.g. a given route in that data set may be derived. The number of time-steps considered may be selected.

In at least some examples, the traffic scenario may comprise or may be assigned to a specific geographic location or region and/or comprises at least one of a traffic segment, a road, a road segment, a route, an area, and an intersection.

In at least some examples, a method for controlling operation of a self-driving vehicle comprises receiving output data indicating a risk profile of a traffic participant of a traffic scenario provided in accordance with the method according to the first aspect, wherein the operation of the self-driving vehicle is related to participating the traffic scenario. Further, the method comprises generating control data for the self-driving vehicle based on the risk profile. In addition, the method comprises controlling operation of the self-driving vehicle based on the control data.

In at least some examples, the methods may be computer-implemented and may be carried out by any suitable data processor, computation device, or the like. The methods may be carried out by a single entity or by multiple entities, a distributed computer system, etc.

In at least some examples, controlling operation of the self-driving vehicle comprises at least one of planning, selecting, altering, and avoiding a specific route and/or driving mission.

Some embodiments include an apparatus for determining a risk profile of a traffic participant of a traffic scenario. An example apparatus comprises interface circuitry configured to receive first data indicating a behavior of the traffic participant and a behavior of surrounding traffic in the traffic scenario, and to receive second data indicating at least one failure mode that can be occurred at the traffic participant to obtain a second risk indicator for hazards for the traffic participant. The apparatus further comprises processing circuitry configured to determine a first risk indicator for hazards for the traffic participant based on the first data. The processing circuitry is further configured to combine the first risk indicator and the second risk indicator to obtain the risk profile of the traffic participant in the traffic scenario. The processing circuitry, and optionally also the interface circuitry, is further configured to provide the risk profile as output data.

The apparatus is configured to carry out the method according to the first and/or second aspect. Therefore, it may be modified in accordance with any one of the examples described herein. For the technical effects of the apparatus, reference is made to the above.

The apparatus may be implemented as a single entity or may be distributed over multiple entities, such as a distributed computer system.

In at least some examples, the apparatus may be operationally connected to control circuitry for at least one self-driving vehicle, the control circuitry being configured to operate the at least one self-driving vehicle based on the risk profile. The apparatus may also be used during development of the self-driving vehicle, e.g. to generate driving software, etc. However, it may also be used in traffic planning, traffic control, etc.

Some embodiments include a non-transitory machine-readable medium having stored thereon a (computer) program having a program code for performing one or more of the methods described herein when the program is executed on a processor or a programmable hardware. Examples may also cover program storage devices, such as digital data storage media, which are machine-, processor-, or computer-readable and encode and/or contain machine-executable, processor-executable, or computer-executable programs and instructions.

Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAS), (F) PGA), graphics processor units (GPU), ASICS, integrated circuits (ICS) or system-on-a-chip (SoCs) systems programmed to execute the steps of the methods described above.

Some embodiments include a (computer) program having a program code for performing one or more of the methods described herein, when the program is executed on a processor or a programmable hardware. Thus, steps, operations or processes of different ones of the methods described above may also be executed by programmed computers, processors or other programmable hardware components.

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

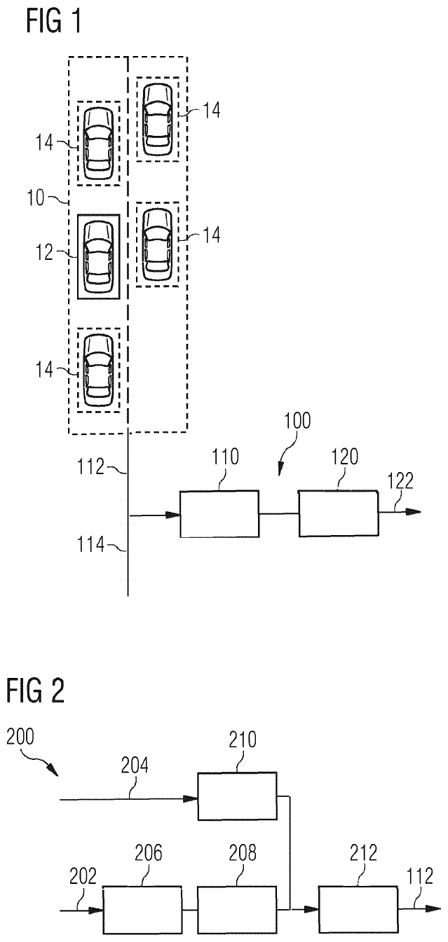

FIG. 1 illustrates an exemplary apparatus 100 for determining a risk profile of a traffic participant of a traffic scenario 10. The traffic scenario 10 may be any kind of traffic situation, driving scenario, driving manoeuvre, or the like, bearing a risk for any traffic participant of it. For example, the traffic scenario 10 may comprise or may be assigned to a specific geographic location or region and/or may comprise or may be assigned to at least one of a traffic segment, a road, a road segment, a route, an area, an intersection, or the like. For illustrative purposes only, the traffic scenario 10 according to FIG. 1 is a road segment that is used by several traffic participants at the same time. It is noted that the principle of determining the risk profile as described herein is applicable to other traffic scenarios. In this example, a traffic participant under consideration, i.e. the traffic participant for which the risk profile is to be determined, is highlighted by a solid-line box and designated by reference sign 12. Surrounding traffic, which may include any number of co-participants of the traffic participant 12 identified to be present in the traffic scene 10, is highlighted by dashed-line boxes and designated by reference sign 14. It is noted that the risk profile may be determined for any one or for multiple of the traffic participant 12 and the surrounding traffic 14. Only for illustrative purpose, the following description refers to determining the risk profile for the traffic participant 12 in the traffic scenario 10. The traffic participant 12 may be, for example, a self-driving car, bus, taxi, or the like, operation of which is to be controlled based on the risk profile. However, the present disclosure is not limited to this.

The apparatus 100 comprises at least interface circuitry 110 and processing circuitry 120. The processing circuitry 120 is operatively connected to the interface circuitry 110.

The interface circuitry 110 is configured to receive first data 112 indicating a behavior of the traffic participant 12 and a behavior of surrounding traffic 14 in the traffic scenario 10. The first data 112 may be at least partially derived from real-life data capturing the traffic scenario 10, such as sensor data, video data, or the like, and/or may be at least partially derived from simulated data comprising a plurality of traffic simulations including the traffic participant 12 and/or the surrounding traffic 14 for the traffic scenario 10. It may also be possible to first determine the traffic scenario 10 from real-life data and then run, e.g. different, simulations for that traffic scenario 10 including the traffic participant 12 and/or the surrounding traffic 14 to obtain the first data 112. Further, the interface circuitry 110 is configured to receive second data 114 indicating at least one failure mode that can be occurred at the traffic participant 12 to obtain a second risk indicator for hazards for the traffic participant 12. By way of example, the second data 114 may be based on derived from a safety case, safety study, a specification, etc. for the traffic participant under consideration. It may also be based on or derived from historic data. In at least some examples, the second data 114 may also be based on or derived from statistical data. For example, the failure mode may be related to a system failure, component failure, but also to a failure due to environmental conditions, e.g., poor visibility, glare, distraction, etc.

The processing circuitry 120 is configured to receive and process the first data 112 and the second data 114. Further, the processing circuitry 120 is configured to determine a first risk indicator for hazards for the traffic participant 12, and optionally of any one of the surrounding traffic 14, based on the first data 112.

For example, determining the first risk indicator may further comprise analyzing movement trajectory data of the first data 112 for its hazardous to the traffic participant 12. In addition, the processing circuitry 120 is configured to determine a second risk indicator for hazards for the traffic participant 12 based on the second data 114. Further, the processing circuitry 120 is configured to combine the first risk indicator and the second risk indicator to obtain the risk profile of the traffic participant 12, and optionally of any one of the surrounding traffic 14, in the traffic scenario 10. The processing circuitry 120, and optionally the interface circuitry 110 is further configured to provide the risk profile as output data 122. For instance, the processing circuitry 120 may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The processing circuitry 120 may optionally be operatively connected to, e.g., read only memory (ROM) for storing software, random access memory (RAM) and/or non-volatile memory. Optionally, the processing circuitry 120 may be operatively connected to a network controller to communicate via a network in order to remotely control a self-driving car, e.g. the traffic participant 12, perform traffic control, or the like.

In at least some examples, the processing circuitry 120 may be further configured to provide the output data 122 for determining control data for and/or controlling of a self-driving vehicle, e.g. traffic participant 12, based on the risk profile. For example, the risk profile may be used to indicate the overall risk of driving on a specific road, route or area, also for a given set of conditions, e.g., time of day, time of year, weather, etc.

In at least some examples, the first data 112 may comprise movement trajectory data of the traffic participant 12 and/or the surrounding traffic 14 indicating the respective behavior. Thereby, analyzing the movement trajectory data may comprise at least one of determining a distance and count of one or more movement trajectories included in the movement trajectory data, determining a time-to-collision, TTC, of one or more movement trajectories included in the movement trajectory data, or determining reachability of one or more movement trajectories included in the movement trajectory data. In at least some examples, the first data 112 may be configured time-step based, each time-step indicating a specific movement scene including the traffic participant 12 and/or the surrounding traffic 14. The determining of the first risk indicator may further comprise determining, for a number of the time-steps, a respective sub-risk indicator by analyzing the respective movement of the traffic participant and/or the surrounding traffic for its hazardous for the traffic participant, and aggregating the sub-risk indicators of the number of the time-steps to obtain the first risk indicator.

Further, in at least some examples, the processing circuitry 120 may be further configured to determine the first risk indicator and/or the second risk indicator further based on at least one environmental condition affective for the traffic scenario. For example, the environmental condition may include natural conditions, traffic conditions, etc. The at least one environmental condition may comprise at least one of a weather condition, a traffic density, and a traffic control restriction. For example, the weather condition may indicate visibility conditions, driving mechanics conditions, or the like. For instance, the traffic control restriction may indicate turning prohibition, or the like.

In addition, in at least some examples, the processing circuitry 120 may be further configured to determine the first risk indicator further based on a type of at least one co-traffic participant identified to be present in the surrounding traffic 14. For example, a bicycle may have a different potential hazard than a car, larger or smaller in some respects, etc.

Further, in at least some examples, the first data 112 may be at least partially derived from simulated data comprising a plurality of traffic simulations including the traffic participant 12 and/or the surrounding traffic 14 for the traffic scenario 10. For example, the processing circuitry 120 may utilize a traffic simulator configured to simulate the traffic scenario 10 or scenes of it.

In addition, in at least some examples, for combining the first risk indicator and the second risk indicator, the processing circuitry 120 may be further configured to determine, for a number of time-steps of the first data 112, the respective hazardous effect of and/or a likelihood for the at least one failure mode for the traffic participant 12, and aggregating the respective hazardous effect and/or likelihood of the number of the time-steps to obtain the risk profile.

FIG. 2 illustrates in a schematic block diagram an example 200 of data processing for deriving the first data 112 indicating a behavior of the traffic participant 12 and a behavior of surrounding traffic 14 in the traffic scenario 10. The data processing shown in FIG. 2 may be performed by any suitable computing device. It may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The computing device may optionally be operatively connected to, e.g., read only memory (ROM) for storing software, random access memory (RAM) and/or non-volatile memory. Optionally, the computing device may be operatively connected to a network controller to communicate via a network. In some examples, the processing circuitry 120 may be configured to perform this data processing.

In FIG. 2, operations 202 and 204 form different branches of the block diagram. In the lower branch, at operation 202, simulated data relating to the traffic participant 12 and/or surrounding traffic 14 may be received. The simulated data may be based on requirements, a specification, historic data, or the like. In the upper branch, at operation 204, real-life data capturing the traffic scene 10 may be received. It is noted that either one or both of the branches of the block diagram may be performed to derive the first data 112.

At operation 206 (see lower branch of the block diagram), representative behavior, e.g. driving behavior, may be derived, e.g. determined, created, generated, or the like.

At operation 208 (see lower branch of the block diagram), multiple, also different, simulations may be performed, e.g. run, for the traffic scene 10 under consideration based on the representative behavior derived at operation 206, for deriving a representative amount of e.g. driving data. For example, at operation 208, multiple feasible driving scenes including the traffic participant 12 and/or the surrounding traffic 14 may be simulated.

At operation 210 (see upper branch of the block diagram), data processing of the real-life data received at operation 204 may be performed for deriving a representative amount of movement, e.g. driving, data. For example, at operation 210, sensor data, e.g. video data, radar data, lidar data, or the like, may be processed.

At operation 212, which may be applied to both the upper branch and the lower branch of the block diagram, trajectory data may be derived from the representative amount of movement, e.g. driving, data. For example, one or more movement trajectories of the traffic participant 12 and/or the surrounding traffic 14 may be derived, e.g. determined, computed, or the like. Further, based on these movement data, the behavior of the traffic participant 12 and/or the surrounding traffic 14 may be determined.

As a result of the above data processing, the first data 112 may be obtained. The first data 112 may also be referred to as risk representative driving data set. In other words, the first data 112 may comprise movement trajectory data of the traffic participant 12 and/or the surrounding traffic 14 indicating the respective behavior, and/or an indicator for that behavior.

In other words, the riskiness of a driving maneuver may generally be determined by the ego vehicle's behavior, e.g. the behavior of the traffic participant 112, in the context of the behavior of the surrounding traffic 14. Therefore, a representative behavior of the ego vehicle and other traffic participants, i.e. the surrounding traffic 14, is to be determined and inserted into a traffic simulation. To derive a dataset that is representative for the driving behavior of the traffic participant 12 and the surrounding traffic 14 and for the route and driving domain of interest, i.e. the risk representative driving dataset, sufficient simulations are to be run to cover all relevant traffic scenarios. It is noted that when assessing the risk of a specific traffic participant 12, e.g. a specific vehicle, self-driving vehicle, or the like, the representative driving behavior may be induced either through the direct insertion of an traffic participant stack in combination with a vehicle simulator or a surrogate traffic participant stack mimicking the characteristic behavior of the traffic participant being assessed. The derived dataset may then be specific for an traffic participant with its behavior in a specific driving context given a (set of) driving missions, e.g. use case of getting from A to B. The quality of simulated driving data relies on a representativeness of the simulated traffic behavior, on the behavior of the surrounding traffic, on the accuracy of the modelling 41 the driving environment in the simulator, and/or the number of simulations.

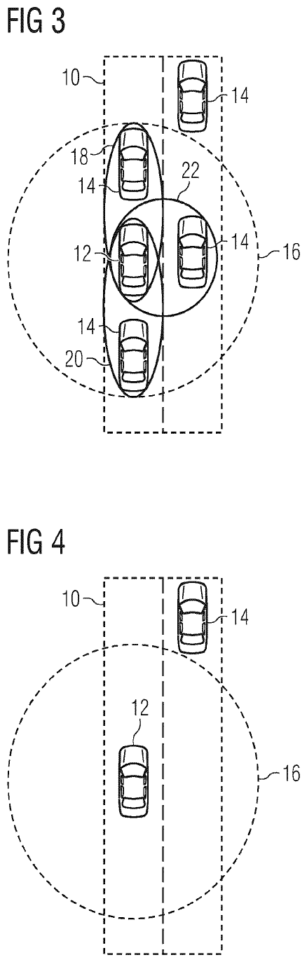

FIGS. 3 and 4 each illustrate an exemplary traffic scenario 10. In FIG. 3, the surrounding traffic 14 and moving the traffic participant 12 therethrough is associated with a rather high risk of the traffic participant. In FIG. 4, however, there is a rather low risk for the traffic participant 12 in the context of surrounding traffic 14.

In each of FIGS. 3 and 4, a radius 16 around the traffic participant 12 is used to analyze the first data 112 with respect to the first risk indicator. While three potential hazards 18, 20, 22 may be identified within radius 16 in FIG. 3, none are identified in FIG. 4. Accordingly, the first risk indicator will be rather high for the example in FIG. 3 and rather low for the example in FIG. 4. It is noted that the radius 16 is merely an example and analyzing the first data 112 may be performed based on another measure.

Referring to FIG. 3, the potential hazards 18, 20, 22 for the traffic participant 12 in the context of the surrounding traffic 14 within the radius 16 may be subject to analyzing movement trajectory data. For example, for each of the potential hazards 18, 20, 22, analyzing the movement trajectory data may comprise at least one of determining a distance and count of one or more movement trajectories included in the movement trajectory data, determining a time-to-collision, TTC, of one or more movement trajectories included in the movement trajectory data, or determining reachability of one or more movement trajectories included in the movement trajectory data. This analysis may be performed by the processing circuitry 120.

For example, the first data 112 may be configured time-step based, each time-step indicating a specific movement scene including the traffic participant 12 and/or the surrounding traffic 14, wherein here each of the potential hazards 18, 20, 22 may be considered.

For determining the first risk indicator, the processing circuitry 120 may be further configured to determine, for a number 4 the time-steps, a respective sub-risk indicator by analyzing the respective movement of the traffic participant and/or the surrounding traffic for its hazardous for the traffic participant, and to aggregate the sub-risk indicators of the number of the time-steps to obtain the first risk indicator. In other words, each simulation time-step within the representative driving data set may provide a specific driving scene, which may be analyzed with the above methods, e.g. distance and count, TTC, or reachability, aggregated over all traffic participants 14 within the radius 16. Applied to all time-steps (or a selected subset of time-steps) across the complete data set, the first risk indicator, and/or the sub-risk indicators, may be aggregated for the complete representative driving data set or for a subset to determine the risk, e.g., for intersection, for route, or for an area; and provided as a risk index. For example, TTC values for a selected area (e.g., intersection) can be averaged over all scenes of all scenarios in the representative data set and used as a risk indicator for that location.

Further, in at least some examples, the processing circuitry 120 may be further configured to classify risk, e.g. by the first risk indicator, for various environmental conditions and/or driving conditions, e.g., influence on traffic due to specific weather conditions, various levels of traffic density, and/or induced operational restrictions and/or traffic control restrictions, e.g., no left turns. Furthermore, the exposure is not limited to vehicles, cars, etc. The presence of bicycles, pedestrians, buses, light rail, human-driven vehicles, trucks, or the like, included in the data set may be used to determine the dependency of the risk index on those factors. Furthermore, the processing circuitry 120 may be configured to compare the differences in behavior of two traffic participant stack, or versions of a single traffic participant stack, e.g., the new version introducing the behavior for overtaking bicycles, and its effect on risk.

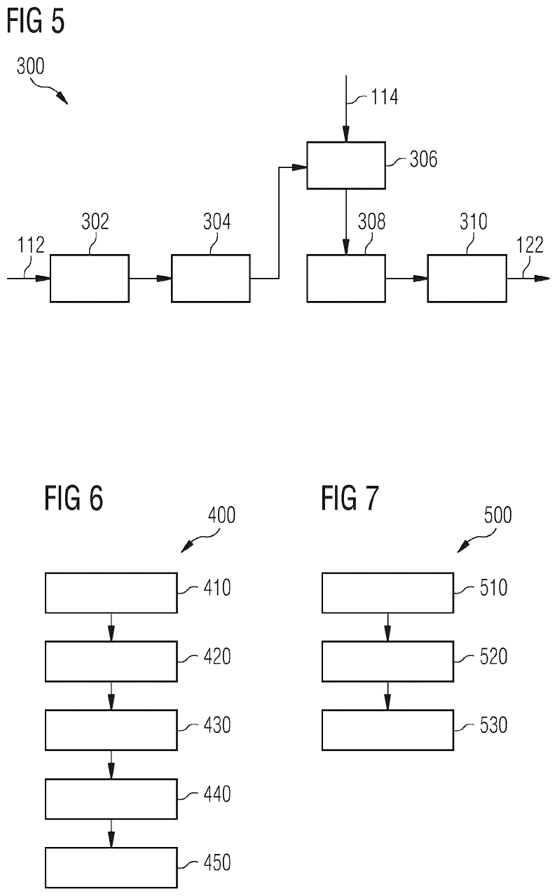

FIG. 5 illustrates in a schematic block diagram an example 300 of data processing for combining the first risk indicator and the second risk indicator to obtain the risk profile, i.e. the output data 122, of the traffic participant 12. The data processing shown in FIG. 5 may be performed by any suitable computing device. It may be a single dedicated processor, a single shared processor, or a plurality of individual processors, some of which or all of which may be shared, a digital signal processor (DSP) hardware, an application specific integrated circuit (ASIC), a neuromorphic processor or a field programmable gate array (FPGA). The computing device may optionally be operatively connected to, e.g., read only memory (ROM) for storing software, random access memory (RAM) and/or non-volatile memory. Optionally, the computing device may be operatively connected to a network controller to communicate via a network. In at least some examples, the processing circuitry 120 may be configured to perform this data processing.

At operation 302, the first data 112, e.g. the risk representative driving data set, may be received, wherein the first data may be configured time-step based. At each time-step, a subset of time-steps, etc., the respective data, e.g. movement trajectory data, may be extracted.

At operation 304, the above-mentioned analysis of the movement trajectory data may be performed. For example, this data processing may comprises analyzing the movement trajectory data may comprise at least one of determining a distance and count of one or more movement trajectories included in the movement trajectory data, determining a time-to-collision, TTC, of one or more movement trajectories included in the movement trajectory data, or determining reachability of one or more movement trajectories included in the movement trajectory data.

At operation 306, the second data 114 may be received and inserted. For example, a time span, e.g. mean time, between failures indicated in the second data 114 may be determined.

At operation 308, the risk, e.g. sub-risk, risk score, or the like, may be computed on time-step level. It may be mapped to spatial coordinates or the like.

At operation 310, the risk(s) may be aggregated on a desired or required level. For example, the risk profile may be obtained by aggregating the risk on desired or required level, e.g. intersection, route, etc. The computation result may be provided as the output data 122.

In other words, for each time-step in the risk representative driving data set, it may be evaluated whether a failure mode could lead to a hazardous event, and/or what the likelihood of such an event would be. By using e.g. mean time between failure from the second data 114, e.g. from safety case, the likelihood and/or severities of these hazardous events may be computed, and a risk index per risk representative data set or for e.g. a given route in that data set can be derived, which may be the risk profile to be included in the output data 122.

For further highlighting the risk profile determination, FIG. 6 illustrates in a flowchart a method 400 for determining a risk profile of a traffic participant of a traffic scenario. The method comprises receiving 410 first data indicating a behavior of the traffic participant and a behavior of surrounding traffic in the traffic scenario. The method further comprises determining 420 a first risk indicator for hazards for the traffic participant based on the first data. Further, the method comprises receiving 430 second data indicating at least one failure mode that can be occurred at the traffic participant to obtain a second risk indicator for hazards for the traffic participant. In addition, the method comprises combining 440 the first risk indicator and the second risk indicator to obtain the risk profile of the traffic participant in the traffic scenario. Furthermore, the method comprises providing 450 the risk profile as output data.

For further highlighting the use of the determined risk profile, FIG. 7 illustrates in a flowchart a method 500 for controlling operation of a self-driving vehicle. The method comprises receiving 510 output data indicating a risk profile of a traffic participant of a traffic scenario provided according to method 400, wherein the operation of the self-driving vehicle is related to participating the traffic scenario. The method further comprises generating 520 control data for the self-driving vehicle based on the risk profile. Further, the method comprises controlling 530 operation of the self-driving vehicle based on the control data.

What is claimed is:

1. A method for determining a risk profile of a traffic participant of a traffic scenario, the method comprising:
receiving first data indicating a behavior of the traffic participant and a behavior of surrounding traffic in the traffic scenario;
determining a first risk indicator for hazards for the traffic participant based on the first data;
receiving second data indicating at least one potential failure mode to obtain a second risk indicator for hazards for the traffic participant;
combining the first risk indicator and the second risk indicator to obtain the risk profile of the traffic participant; and
providing the risk profile as output data.

2. The method of claim 1, further comprising using the output data control a self-driving vehicle based on the risk profile.

3. The method of claim 1, wherein the first data comprises movement trajectory data of the traffic participant, and/or the surrounding traffic indicating respective behavior.

4. The method of claim 3, wherein determining the first risk indicator further comprises analyzing the movement trajectory data for its hazardous effect to the traffic participant.

5. The method of claim 1, wherein:
the first data includes a plurality of time-steps indicating a specific movement scene including the traffic participant and/or the surrounding traffic (4), and
determining the first risk indicator further comprises
determining, for a number of the pluarlity of time-steps, a respective sub-risk indicator by analyzing the respective movement of the traffic participant and/or the surrounding traffic and
aggregating the sub-risk indicators of the number of the time-steps to obtain the first risk indicator.

6. The method of claim 1, wherein determining the first risk indicator and/or the second risk indicator includes assessing at least one environmental condition for the traffic scenario.

7. The method of claim 1, wherein determining the first risk indicator includes assessing a type of at least one co-traffic participant identified in the surrounding traffic.

8. The method of claim 1, wherein the first data is at least partially derived from real-life data capturing the traffic scenario.

9. The method of claim 1, wherein the first data is at least partially derived from simulated data comprising a plurality of traffic simulations including the traffic participant and/or the surrounding traffic for the traffic scenario.

10. The method of claim 1, wherein the second data comprises at least one safety metric indicating a corresponding failure mode of the traffic participant.

11. The method of claim 1, wherein the failure mode relates to a failure of a technical system and/or a likelihood of a failure of a technical system of the traffic scenario.

12. The method of claim 1, wherein:
the first data includes a plurality of time-steps, each time-step indicating a specific scene of the traffic scenario; and
combining the first risk indicator and the second risk indicator further comprises
determining, for a number of the time-steps, the respective hazardous effect of and/or a likelihood for the at least one failure mode for the traffic participant, and
aggregating the respective hazardous effect and/or likelihood of the number of the time-steps to obtain the risk profile.

13. The method of claim 1, wherein the traffic scenario comprises or is assigned to a specific geographic location or region and/or comprises at least one of a traffic segment, a road, a road segment, a route, an area, and an intersection.

14. (canceled)

15. An apparatus for determining a risk profile of a traffic participant of a traffic scenario, the apparatus comprising:
an interface to
receive first data indicating a behavior of the traffic participant and a behavior of surrounding traffic in the traffic scenario and
second data indicating at least one potential failure mode of the traffic participant and a second risk indicator for hazards for the traffic participant; and
processing circuitry configured to
determine a first risk indicator for hazards for the traffic participant based on the first data,
combine the first risk indicator and the second risk indicator to obtain the risk profile of the traffic participant and
provide the risk profile as output data.
